(19) United States
(12) Patent Application Publication
(10) Pub. No.: US 2024/0342744 A1
(43) Pub. Date: Oct. 17, 2024

(54) COATING MATERIAL APPLICATION METHOD AND APPLICATION SYSTEM

(71) Applicant: VARDEN PROCESS PTY LTD, Braeside, Victoria (AU)

(72) Inventors: Stuart GORDON, Braeside, Victoria (AU); Mark APPLEFORD, Braeside, Victoria (AU)

(21) Appl. No.: 18/579,706

(22) PCT Filed: Jul. 15, 2022
(86) PCT No.: PCT/AU2022/050749

§ 371 Date: Jan. 16, 2024

(30) Foreign Application Priority Data
Jul. 16, 2021 (AU) 2021902187

(51) Int. Cl. B05C 7/04; B05C 9/14; B05C 11/10; B05D 1/26; B05D 7/22

(52) U.S. Cl. CPC B05C 7/04; B05C 9/14; B05C 11/1013; B05C 11/1044; B05D 1/26; B05D 7/227; B05D 2259/00; B05D 2501/10

(57) ABSTRACT

A method is provided of applying a coating material to a concave surface of an article that has a rim around the concave surface, and a cavity between the concave surface and the rim. The method includes discharging coating material in a liquid form into the cavity, extracting a first amount of the discharged liquid coating material from the cavity, thereby leaving a residual amount of the liquid coating on the concave surface within the cavity, and maintaining the article in conditions appropriate to allow the residual amount of liquid coating material to cure on the concave surface.

### FIELD OF THE INVENTION

The present invention relates to a method of applying a coating material to a concave surface of an article, and an application system for use in coating a concave surface of an article with a coating material.

### BACKGROUND

It is known to apply a coating material to a surface of a preform of a base material so that final product (which may be at least the preform with the coating material applied) has properties and/or characteristics that are not possible with the material of the preform alone.

By way of example, it is known to apply a coating of wax to paperboard so that the wax-coated paperboard has a resistance to water. In this example, the wax can be coated by a spray-coating process that broadly involves heating wax to a temperature above its solid-to-liquid transition temperature, and spraying the liquid wax onto the surface of the paperboard. The temperature of the paperboard is below the solid-to-liquid transition temperature of the wax, so that the wax hardens on contact.

Spray-coating processes are beneficial for relatively flat surfaces, where there is minimal variation of the relative positions of the spray nozzles and the target surface during the coating process. This enables the coating material to be applied with a predictable relatively uniform thickness. However, spray-coating processes are less suitable for coating materials onto a curved target surface. To this end, achieving a uniform thickness of a coating material on a target surface that has portions with small radii, and/or varied radii by spray-coating processes is difficult and time-consuming. These difficulties are exacerbated for concave target surfaces. In addition, where only part of a surface of a preform is to be coated, the surface outside of that part must be masked to prevent overspray coating in unwanted regions of the surface.

By way of another example, it is known to apply a coating of wet glaze (typically minerals and metal oxides in an aqueous suspension) onto surfaces of unfired ceramic material. During fired, the glaze solids fuse with one another and with the ceramic material to create an impervious coating on the ceramic material. One method of coating wet glaze involves dipping the ceramic into a bath of the wet glaze. As the ceramic is withdrawn from the bath, excess wet glaze is allowed to flow off the target surface. The rheology of the wet glaze that facilitates this type of dip coating is such that achieving a uniform thickness in the final coating is difficult to obtain. Thus, the result is that in practice coating material is applied to some parts of the target surface in excess, in order to obtain a minimum desired thickness of coating material across the target surface. As will be appreciated, this process leads to wasted application of the coating materials.

A similar coating process for concave surfaces, such as the inner surface of ceramic bowl, involves filling the concavity with the wet glaze, and then tipping/pouring out the excess. Where only a concave surface of a preform is to be coated, the tipping/pouring phase can lead to wet glaze flowing to unwanted regions of the preform surface.

It will be appreciated that spray-coating, dipping and pouring processes can be employed with other coating materials, and also with preforms formed of other base materials.

There is a need to address the above, and/or at least provide a useful alternative.

### SUMMARY

There is provided a method of applying a coating material to a generally concave surface of an article, the article further having a rim around the concave surface, and a cavity that is defined between the concave surface and the rim, the method involving:
discharging coating material in a liquid form into the cavity,
extracting a first amount of the discharged liquid coating material from the cavity, thereby leaving a residual amount of the liquid coating on the concave surface within the cavity, and
maintaining the article in conditions appropriate to allow the residual amount of liquid coating material to cure on the concave surface.

The method can further involve using an application system having a nozzle with a tip end and at least one lumen extending through the nozzle to an opening at the tip end, and
prior to discharging liquid coating material into the cavity, the method further involves positioning the nozzle with the tip end in the cavity,
wherein liquid coating material is discharged into the cavity from the opening.

Positioning the nozzle can involve locating the tip end of the nozzle with the opening proximate the concave surface.

In some examples, the method can involve withdrawing the nozzle while simultaneously discharging liquid coating material into the cavity. In some alternative examples, the method involves keeping the nozzle stationary while discharging liquid coating material into the cavity.

Extracting the first amount of the discharged liquid coating material can involve applying a negative pressure differential to the lumen of the nozzle, to thereby draw the first amount of the discharged liquid coating material from the cavity via the nozzle.

Positioning the nozzle can involve positioning the tip end of the nozzle at a predetermined position relative to the concave surface. The predetermined position can be at a predetermined vertical separation from a lowest part of the concave surface having regard to the orientation of the article during the filling and extraction steps, and the nozzle is stationary at the predetermined position while discharging liquid coating material into the cavity, and/or while extracting the first amount of liquid material coating.

In some alternative examples, the nozzles of the application system include a delivery nozzle, and an extraction nozzle that has a tip end and at least one lumen extending through the extraction nozzle to an opening at the tip end, and the method further involves:
inserting the tip end of the extraction nozzle into the discharged liquid coating material, and
drawing liquid coating material through the extraction nozzle to thereby extract the first amount of the discharged liquid coating material from the cavity.

Inserting the tip end of the extraction nozzle into the discharged liquid coating material can involve positioning the tip end of the extraction nozzle at a predetermined position relative to the concave surface. The predetermined position can have the tip end of the extraction nozzle at a predetermined vertical separation from a lowest part of the concave surface, having regard to the orientation of the article during the filling and extraction steps.

In some examples, the extraction nozzle is stationary at the predetermined position while extracting the first amount of discharged liquid material coating.

The method can involve inserting the tip end of the extraction nozzle into the discharged liquid coating material to thereby displace coating material upwardly and towards the rim of the cavity. In at least some examples, the method involves discharging a predetermined volume of liquid coating material into the cavity, the predetermined volume being less than the volumetric capacity of the cavity.

In some alternative examples, the step of drawing liquid coating material through the extraction nozzle commences prior to the extraction nozzle arriving at the predetermined position.

In some examples, while discharging liquid coating material into the cavity, the tip end of the delivery nozzle is spaced vertically from the surface level of the discharged liquid coating material. The method can involve withdrawing the delivery nozzle from the cavity while discharging liquid coating material. In some particular instances, while discharging liquid coating material into the cavity, the tip end of the delivery nozzle is positioned at or above the rim of the article.

The method can involve removing the delivery nozzle from the cavity after liquid coating material is discharged into the cavity, and prior to extracting the first amount of liquid coating material from the cavity.

In certain examples, the cavity is to be at least partially filled with a predetermined volume of liquid coating material prior to the extracting step, and the step of discharging liquid coating material into the cavity further involves measuring the volumetric flow of liquid coating material through the nozzle, and controlling the discharge of liquid coating material based on the measured volumetric flow.

In certain other examples, the step of discharging liquid coating material into the cavity involves discharging the liquid coating material for a predetermined period of time.

The application system can include a sensor for sensing the level of the liquid coating material that is within the cavity and relative to a datum associated with one of: the position of the article, or a support bed on which the article is positioned during the discharging step,
and wherein the step of discharging liquid coating material into the cavity further involves sensing the level of the liquid coating material, and ceasing the discharge of liquid coating material when the liquid coating material level within the cavity reaches a predetermined height relative to the datum.

The application system can alternatively include a trigger device that has a port, and that in use has two states and is configured to change between those two states in response to the presence of liquid coating material, the port of the device being located at a predetermined position relative to the tip end of the discharge nozzle,
and wherein the step of discharging liquid coating material into the cavity ceases when the trigger device changes between its two states.

The method can further include a dwell time after liquid coating material is discharged into the cavity, and prior to commencing extraction of the first amount of the liquid coating material,
wherein during the dwell time at least part of the residual amount of liquid coating material commences curing on the concave surface.

The application system can include a support bed with one or more location formations, such that the support bed is to support the article with the concave surface facing upward and located in a predetermined position by the location formations, and the method further involves loading the article onto the support bed prior to discharging the liquid coating material into the cavity.

The method can additionally involve applying a locating force to the article to thereby bias the article against the support bed formation.

There is also provided an application system for use in coating a generally concave surface of an article with a coating material, the article further having a rim around the concave surface, and a cavity that is defined between the concave surface and the rim, the application system comprising:
a reservoir within which to contain the coating material in a liquid form,
one or more nozzles that each have a tip end, and at least one lumen that extends through the nozzle to a respective opening at the tip end, and
a coating material transport subsystem that is in communication with the reservoir and the nozzles, the coating material transport subsystem being configured to deliver liquid coating material to at least some of the lumens for discharge via the respective openings, and to draw liquid coating material into at least some of the nozzles from externally of the respective nozzle.

In one example, the coating material transport subsystem further comprises:
a first flow path through which to transport liquid coating material from the reservoir to a first set of the lumens for discharge via the respective openings, and
a second flow path through which to transport liquid coating material from externally of the respective nozzles, into and through a second set of lumens to the reservoir.

The coating material transport subsystem can further comprise:
a set of conduits that define the first and second flow paths, and
one or more pumps for moving the liquid coating material through the set of conduits.

Preferably, the application system includes:
at least one support bed with one or more location formations that are each shaped to locate the article to a predetermined position on the support bed with the concave surface oriented upwardly with respect to the support bed,
a nozzle support chassis on which the nozzles are mounted, and
a reciprocation mechanism that is configured to move the nozzle support chassis or the support bed, such that the nozzles are movable relative to the support bed between a deployed position in which in use of the application system the tip ends of the nozzles are located within the cavity of the article, and an elevated position in which the tip ends are spaced above the support bed.

In some examples, the location formations include concave nesting formations that complement convex surface portions on the underside of the article,
whereby when the article is supported on the support bed, the convex surface portions on the underside of the article nest within the concave nesting formations.

Preferably, the support bed has a datum plane, and the concave nesting formations are located to a lower side of the datum plane,
wherein:
   when the nozzles are in the deployed position, the tip ends are located below the datum plane, and
   when the nozzles are in the elevated position, the tip ends are spaced above the datum plane.

In some examples, the application system is configured such that when the nozzles are in the deployed position, the nozzles project through the datum plane. Alternatively or additionally, the application system is configured such that when the nozzles are in the deployed position, the tip ends are disposed at a predetermined insertion depth from the datum plane in a direction that is normal to the datum plane. In certain examples, the predetermined insertion depth is adjustable.

The nozzle support chassis can include limit stops that at least partially define the deployed position, and that also limit the movement of the nozzles in away from the elevated position. Preferably, the limit stops are adjustable to enable adjustment of the deployed position.

The support bed and/or nozzle support chassis can include guides that constrain the movement of the nozzle support chassis. Preferably, the guides constrain the movement of the nozzle support chassis in directions that are transverse to the movement of the nozzles between the elevated and deployed positions.

Preferably, the nozzles are mounted on the nozzle support chassis in one or more linear rows.

In certain examples, each nozzle includes at least one discharge lumen that is interconnected with the first flow path, and at least one extraction lumen that is interconnected with the second flow path.

Alternatively or additionally, the coating material transport subsystem can be configured such that at least some of the lumens of each nozzle are interconnected with both the first and second flow paths, whereby liquid coating material can be discharged from, and drawn into the respective lumens.

In some examples, the nozzles include:
a first set of nozzles that are interconnected with the first flow path, and
a second set of nozzles that are interconnected with the second flow path,
wherein, in use of the application system to coat the concave surface of an article, liquid coating material is discharged into the cavity via one of: the first or second set of nozzles, and liquid coating material is drawn from the cavity into the second flow path via the other of: the second or first set of nozzles.

In some examples, the nozzles include:
one or more delivery nozzles that are interconnected with the first flow path, and
one or more extraction nozzles that are interconnected with the second flow path,
wherein, in use of the application system to coat the concave surface of an article, liquid coating material is discharged into the cavity via the delivery nozzles, and liquid coating material is drawn from the cavity into the second flow path via the extraction nozzles.

The delivery and extraction nozzles can be mounted on the nozzle support chassis, and arranged such that:
the delivery nozzles are mounted in a delivery nozzle array,
the extraction nozzles are mounted in an extraction nozzle array, and
the tip ends of the deliver and extraction nozzles are in fixed positions relative to the nozzle support chassis.

In one arrangement, the delivery nozzle array has a single row of delivery nozzles, and the extraction nozzle array has a single row of extraction nozzles,
wherein the row of delivery nozzles are spaced from the extraction nozzles in a direction that is transverse to the movement of the direction of nozzle movement between the elevated and deployed positions.

Preferably, the row of delivery nozzles is linear, and the row of extraction nozzles forms is linear.

In certain examples, the nozzle support chassis comprises a first frame on which the delivery nozzles are mounted, and a second frame on which the extraction nozzles are mounted,
wherein the reciprocation mechanism is configured to move the first frame and the second frame independently of one another.

The application system can further include a support bed translation mechanism that is configured to move the support bed along a process path,
wherein, in at least one direction of movement of the support bed along the process path, the support bed halts to allow the delivery nozzles to reciprocate from the elevated position to the deployed position in the concave nesting formations and subsequently to allow the extraction nozzles to reciprocate from the elevated position to the deployed position in the respective concave nesting formations.

Alternatively or additionally, the support bed translation mechanism is configured to index the support bed along the process path in at least one direction through a set of two or more predetermined positions,
wherein each predetermined position corresponds with concave nesting formations being located such that at least one of the nozzles is locatable in its deployed position within cavity of the respective concave nesting formations.

The arrays of delivery nozzles and extraction nozzles can be arranged so that, in use the of the application system, and while the support bed is located at each of the predetermined positions, delivery nozzles are to discharge liquid coating material into the cavities of a group of articles and the extraction nozzles are to draw liquid coating material from the cavities of another distinct group of articles.

Alternatively, the arrays of delivery nozzles and extraction nozzles can be arranged so that, in use the of the application system, and while the support bed is located at each of the predetermined positions, delivery nozzles are to discharge liquid coating material into the cavities of a group of articles and the extraction nozzles are to draw liquid coating material from the cavities of that same group of articles.

In at least some instances, the support bed has an array of concave nesting formations that are arranged in the datum plane into linear rows and columns.

The rows of the array of concave nesting formations are preferably parallel with the rows of the delivery and extraction nozzles.

Preferably, each nozzle is mounted on the nozzle support chassis to align centrally with one of the columns in the array of concave nesting formations.

Nozzles of the application system that are to be at least partially immersed in the liquid coating material (or otherwise inserted into the discharged liquid coating material) while drawing liquid coating material into at least some of the nozzles from externally of the respective nozzle can be constructed to have outer surfaces with a surface energy that is lower than that of the liquid coating material.

The application system can include a support bed temperature management subsystem that enables the temperature of the support bed to be maintained at a predetermined temperature. The predetermined temperature is to be below the liquid-solid phase transition temperature of the coating material. Preferably, the predetermined temperature is adjustable.

The application system can include a locating subsystem to facilitate supporting the article against the concave nesting formations, the locating subsystem being arranged to apply a force against the article when loaded onto the support bed to urge the article into contact with the concave nesting formations.

In one form, the locating subsystem can include clamping system with one or more jaws, wherein the clamping system is configured to clamp a portion of the article between the support bed and the jaws.

Alternatively or additionally, the locating subsystem can include a vacuum system that includes vacuum tubes extending through the support bed and open into the concave nesting formations, wherein the clamping system is configured to draw air from above the concave nesting formations, and thereby apply a suction force against the article.

The coating material transport subsystem includes one or more flowmeters that are configured to measure the flow rate of liquid coating material that is discharged from the respective openings of the nozzles. In at least some examples, the coating material transport subsystem is arranged with one of the flowmeters associated with a respective one of the nozzles to measure the flow rate that is discharged from the opening of that respective nozzle. The coating material transport subsystem can also be configured to measure the flow rate of liquid coating material that is drawn into the nozzles from externally of the nozzles.

The coating material transport subsystem can include one or more sensors for sensing the level of the liquid coating material that is within the cavity of the article and relative to a datum associated with one of: the position of the article on the support bed, the nozzle support chassis, and/or the support bed, wherein the application system is configured to:
obtain data from the sensors while the coating material transport subsystem delivers liquid coating material for discharge from the nozzles, and
cease discharge of liquid coating material from the nozzles when the sensed level of liquid coating material reaches a predetermined proximity to the rim of the article.

Preferably, the sensors use ultrasonic energy, or electro-magnetic energy to sense the level of the liquid coating material. In one form, the sensors can be laser sensors.

The coating material transport subsystem can include a solenoid valve associated with each discharge nozzle, and the application system is configured to close each solenoid valve to thereby cease discharge of liquid coating material from the respective nozzle when the sensed level of liquid coating material reaches the predetermined proximity to the rim of the article into which liquid coating material is discharged from the respective nozzle.

Alternatively or additionally, the coating material transport subsystem can include:
a vacuum pump;
   one or more trigger devices that are each associated with a respective one of the nozzles, and each have:
      a port through which to draw fluid, the port being in fluid communication with the vacuum pump, and being at a predetermined separation from the tip end of the respective nozzle,
      a first state that is associated with a first gas pressure at the port, and
      a second state that is associated with a second gas pressure at the port, the second gas pressure being a lower pressure than the first gas pressure; and
   one or more valves that are each associated with a respective nozzle and interconnecting with the corresponding trigger device of that respective nozzle,
   wherein each valve has a first operating state in which liquid coating material is able to flow into the lumen of the respective nozzle from the reservoir for discharge via the respective opening, and a second operating state in which the valve is closed to flow of liquid coating material from the reservoir, wherein the transition of the respective trigger device from its first state to its second state causes the valve to transition from its first operating state to its second operating state.

In one example, each trigger device includes a venturi mechanism.

### BRIEF DESCRIPTION OF THE DRAWINGS

In order that the invention may be more easily understood, embodiments will now be described, by way of example only, with reference to the accompanying drawings, in which:

FIG. 1: is a formed blank with vessels interconnected by a web, each vessel having a concave surface to which a coating material is to be applied;

FIG. 2: is an upper perspective view of the vessel that has a coating material applied by a coating material application procedure of an embodiment, and subsequently trimmed;

FIG. 3: is a process schematic of an application system according to a first embodiment;

FIG. 4: is a schematic vertical section of the blank as viewed along the line IV-IV in FIG. 1, together with the support bed of the application system of FIG. 2, in a first phase of a coating material application procedure according to an embodiment;

FIG. 5: shows the blank and support bed of FIG. 4, with the blank loaded into the support bed;

FIG. 6: shows the blank and support bed of FIG. 5, with a set of nozzles of the application system inserted into the concave portions of the vessels;

FIG. 7: is a schematic vertical section of the blank as viewed along the line VII-VII in FIG. 1, together with the support bed and nozzle sets of the application system of FIG. 3,

FIG. 8: is an enlarged view of Region A in FIG. 7;

FIG. 9: is an enlarged view of Region B in FIG. 7;

FIG. 10: is an enlarged view of Region C in FIG. 7;

FIG. 11: is a lower perspective view of the tip of an application system nozzle according to a second embodiment;

FIG. 12: is a vertical cross section view of the tip shown in FIG. 11;

FIG. 13: is a lower perspective view of the tip end of an application system nozzle according to a third embodiment;

FIG. 14: is a bottom view of the tip end shown in FIG. 13;

FIG. 15: is a vertical cross section of the tip end of FIG. 13;

FIG. 16: is a schematic vertical section of the tip end of FIG. 13 positioned for application of a coating material to a concave surface of a vessel;

FIG. 17: is a lower perspective view of the tip end of an application system nozzle according to a fourth embodiment;

FIG. 18: is a process schematic of an application system according to a fifth embodiment and incorporating the tip end of the nozzle of FIG. 17;

FIG. 19: is a vertical cross sectional view through a vessel of another example;

FIG. 20: is a further view of the vessel of FIG. 19, showing a first phase of a coating material application procedure according to an embodiment;

FIG. 21: is a further view of the vessel of FIG. 19, showing a second phase of a coating material application procedure according to an embodiment; and

FIG. 22: is a further view of the vessel of FIG. 19, with the applied coating.

### DETAILED DESCRIPTION

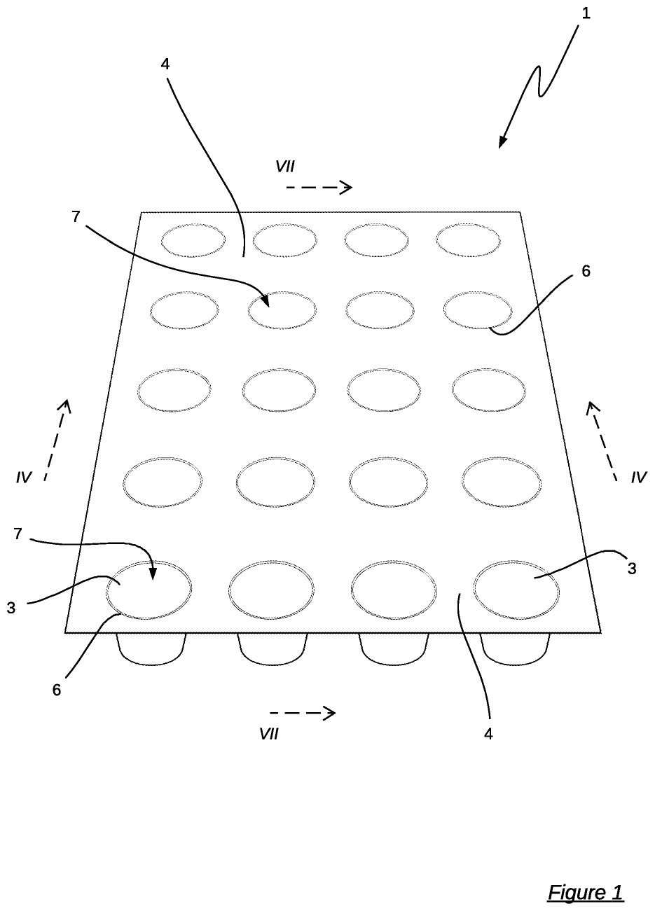

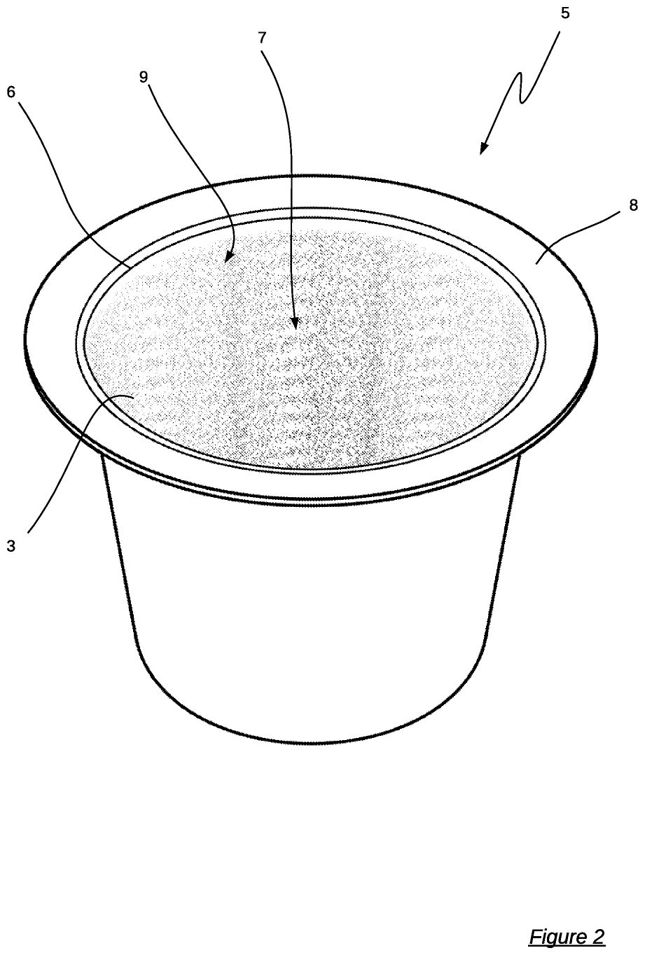

FIG. 1 is an upper perspective view of a formed blank 1 with twenty formations that each have concave surface 3. The twenty formations are interconnected by a web 4. The blank 1 is to be further processed to include a coating material, and then trimmed to form twenty vessels 5, one of which is shown in FIG. 2. Each vessel 5 has a rim 6 around the concave surface 3, and a cavity 7 that is defined between the concave surface 3 and the rim 6. In this particular example, the vessel 5 has an annular flange 8 radially outwardly of the rim 6. As will be apparent, annular flange 8 is formed from the web 4 of the blank 1, following the trimming process.

With respect to this particular example, the coating material applied to the concave surface 3 (the coating is indicated by reference number 9 in FIG. 2) does not coat the vessel 5 radially outwardly of the rim 6. In other words, the annular flange 8 is to remain uncoated (of the applied coating material), and thus is exposed raw material from which the blank 1 is formed.

FIG. 3 is a schematic illustration of an application system 10 for use in coating a concave surface of an article with a coating material. By way of an illustrative example only, the application system 10 is suitable for use in applying a coating material to the concave surfaces 3 of the blank 1. Thus, after application of the coating 9, and a subsequent trimming operation performed on the blank 1, the vessel 5 is formed.

For simplicity in the description that follows, a method of applying a coating material will be described with reference to the blank 1 and/or the vessel 5 (except where the context more suitably refers to an article), and similarly with respect to the application system 10. In an example, the coating material can be a wax, which at typical room temperatures is a solid, and at elevated temperatures changes to a liquid phase. It is known that at least some waxes change from their solid phase to their liquid phase progressively through a range of temperatures. A nominal solid-to-liquid transition temperature is the temperature above which substantially all of the wax is in liquid form. For further simplicity of the description that follows, wax is used as an illustrative example of the coating material.

The application system 10 has a reservoir within which to contain the wax W in a liquid form. The reservoir, which in this example is in the form of a tank 12, has a raw wax feed inlet 14, and a heater 16 and agitator 18 to keep the wax W within the tank 12 in a liquid state and above its solid-to-liquid transition temperature.

The application system 10 includes a support bed 20 with location formations on an upper surface. The location formations are shaped such that in use of the application system 10 the blank 1 locates to a predetermined position on the support bed with the concave surfaces 3 oriented upwardly with respect to the support bed 20.

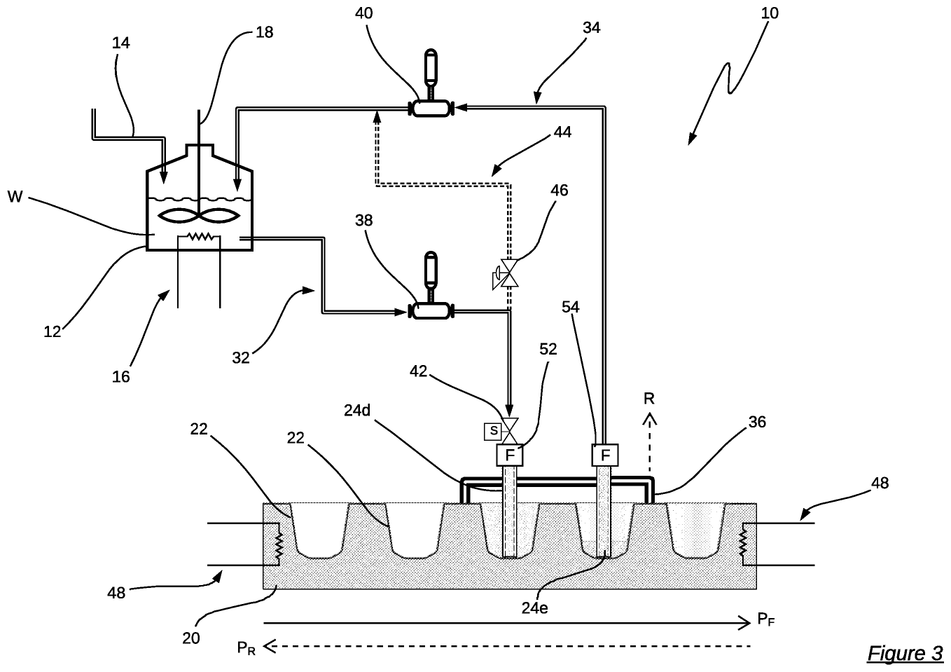

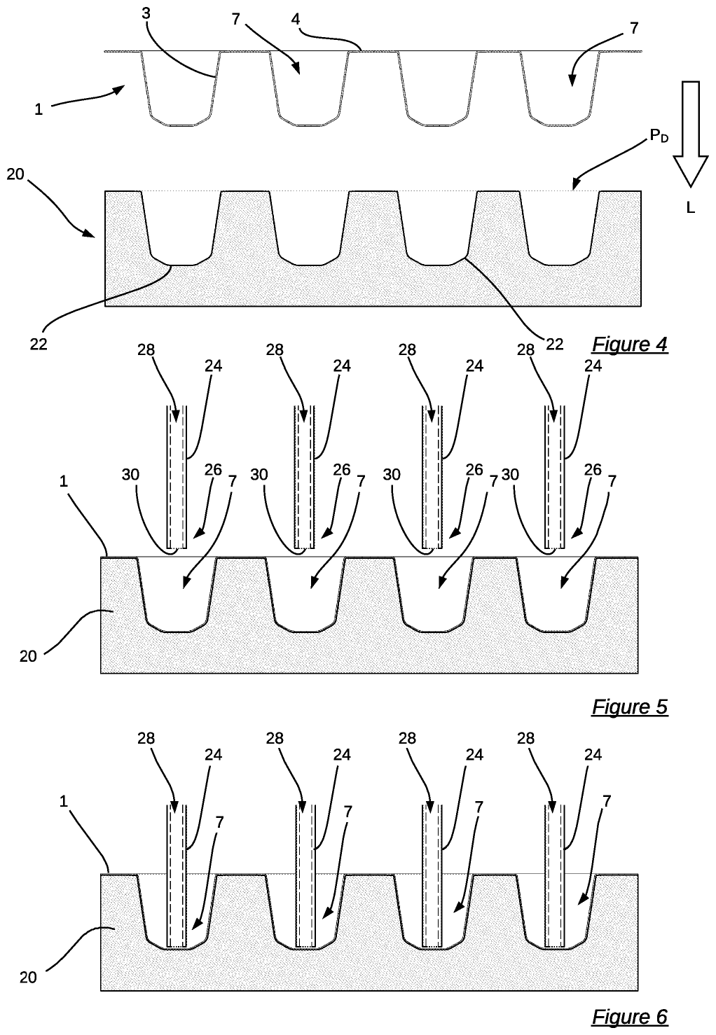

In the illustrated example, the blank 1 has the general form of a contoured sheet material of approximately constant sheet thickness. The underside of the blank 1 has a convex surface portions that are complementary of the concave surfaces 3. Further, the location formations of the support bed 20 are in the form of concave nesting formations 22 that are evident from FIG. 4, which shows the support bed 20 and blank 1 in vertical schematic cross section, with the blank 1 above and spaced from the support bed 20.

The support bed 20 has a datum plane P_{D}, which in this particular example is coincident with the upper peripheral edges of the concave nesting formations 22. The concave nesting formations 22 are located to a lower side of the datum plane P_{D}.

The application system 10 includes a set of nozzles 24. As indicated in FIG. 5, each nozzle 24 has a tip end 26, and a lumen 28 that extends through the nozzle to an opening 30 at the tip end 26.

The tank 12 is in fluid communication with the nozzles 24 via a coating material transport subsystem. As described in further detail below, in use of the application system 10 the coating material transport subsystem delivers liquid wax W from the tank 12 to lumens 28 of some of the nozzles 24 for discharge via the respective openings 30. Further, in use of the application system 10 the coating material transport subsystem draws liquid wax W into some of the nozzles 24 from externally of those respective nozzles 24. Thus, the application system 10 is operable to discharge liquid wax W into the cavities 7 of the blank 1, and extract a first amount of the discharged liquid wax W from the cavities 7, thereby leaving a residual amount of the liquid wax W within those cavities 7.

By filling each cavity 7 with liquid wax W to a level that is at, just below the rim 6, and then extracting some of the discharged liquid wax W back out of the cavity 7, a thin layer of wax W (being the residual amount of liquid wax W) remains on the concave surface 3. By then maintaining the blank 1 with the residual amount of liquid wax W on the concave surface 3 to cool, that residual amount of liquid wax W cures and a coating of solid wax W forms on the concave surface 3.

It will be appreciated that the process described above results in the surface of the web 4 being bare material of the blank 1. This has certain benefits to the final product, and/or benefits to the manufacturer in various factors. With respect to the vessel 5 (which is trimmed from the blank 1 after the wax W is applied by the application system 10), it will be apparent from the description and from FIG. 2 that the result is that the concave surface 3 of the vessel 5 has a coating of wax W, but that the annular flange 8 is devoid of the wax W. That is, the upper surface of the annular flange 8 is uncoated base material from which the blank 1 is formed. In other words, the process is such that the surface that is radially outward of each rim does not have the coat material applied thereto.

It will also be appreciated that the conditions that are appropriate for the liquid coating material to cure are dependent on the actual coating material, its characteristics, and the nature of the change/transformation that is required to achieve that cure. By way of example, for coating materials that are wax-based, and similar materials where curing involves a liquid-to-solid phase change, the process may involve enabling heat from the article and liquid coating material to transfer to other medium, such as to gases in the surrounding environment (to facilitate convective heat transfer), and/or to solid materials that are in contact with the article (to facilitate conductive heat transfer). In another example, for coating materials for which curing involves an endothermic chemical reaction, and/or involves a heat induced internal structural change in the coating material, the process may involve baking the article and liquid coating material at an elevated temperature.

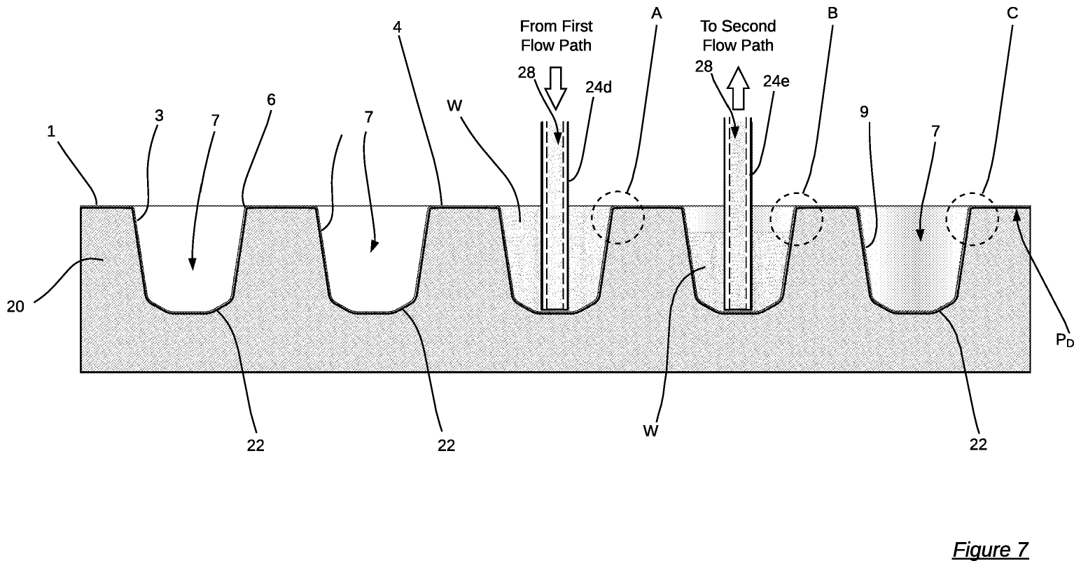

In this particular example, the nozzles 24 are arranged into a set of delivery nozzles 24d, and a set of extraction nozzles 24c, as shown in FIGS. 3 and 7. The coating material transport subsystem has a first flow path 32 for transporting wax W from the tank 12 to the lumens 28 of the delivery nozzles 24d, and a second flow path 34 for transporting wax W that is drawn from the region surrounding the openings of the extraction nozzles 24e, into and through the lumens 28, and to the tank 12.

The application system 10 includes a nozzle support chassis 36 on which the nozzles 24 are mounted. A reciprocation mechanism (not shown) is configured to move the nozzle support chassis 36, and thus also the nozzles 24. The reciprocation mechanism moves the nozzle support chassis 36—and thus also the nozzles 24—relative to the support bed 20 between a deployed position, and an elevated position. In use of the application system 10, when in the deployed position, the tip ends of the nozzles 24 are located within the cavities 7 of the blank 1. Further, the tip ends of the nozzles 24 are located below the datum plane P_{D}, and the nozzles project through the datum plane P_{D}. When the nozzles 24 are in the elevated position, the tip ends of the nozzles 24 are spaced above the support bed 20. Further, in the elevated position, the tip ends are spaced above the datum plane P_{D}.

FIG. 3 illustrates the application system 10 with the nozzles 24 in the deployed position. The movement of the nozzle support chassis 36 and nozzles 24 away from this position towards the elevated position is indicated by dashed arrow R. In this particular example, the reciprocation mechanism is arranged to move the nozzles 24 and nozzle support chassis 36 in translational movement only, and that translation is in a direction is orthogonal to the datum plane P_{D} of the support bed 20. However, in some other examples, the reciprocation mechanism may also rotate the nozzles 24 and nozzle support chassis 36 between the deployed and elevated positions. Alternatively or additionally, the reciprocation mechanism can be arranged to translate the nozzles and nozzle support chassis in two or three planes.

The application system 10 also has a support bed translation mechanism (not shown) that is configured to move the support bed 20 along a process path. The process path is indicated in FIG. 3 by solid line arrow Pr. The application system 10 is configured to coordinate movement of the reciprocation mechanism and the support bed translation mechanism. In this example, the support bed translation mechanism is also arranged to move the support bed 20 in the reverse direction along the process path P_{F}, as indicated in FIG. 3 by dashed line arrow P_{R}.

Further, when moving the support bed 20 along the process path P_{F} the application system 10 controls the support bed translation mechanism to halt the movement of the support bed 20 to allow the nozzles 24 to reciprocate from the elevated position to the deployed position. To this end, the support bed translation mechanism is configured to index the support bed 20 along the process path P_{F} through a set of predetermined positions. Each predetermined position corresponds with the concave nesting formations 22 being located such that the nozzles 24 are movable from the elevated positions to the deployed positions within cavities 7 of the blank 1.

The coating material transport subsystem includes a set of conduits (shown schematically in FIG. 3) that define the first and second flow paths 32, 34. In this example, the coating material transport subsystem has an outflow pump 38 in the first flow path 32, and a return-side pump 40 in the second flow path 34. In examples in which the application system 10 has more than one delivery nozzle 24d, the first flow path 32 separates downstream of the outflow pump 38 to divide the flow of liquid wax W to the delivery nozzles 24d. In this way, the set of delivery nozzles 24d are all supplied with liquid wax W from the same source. Similarly, where there is more than one extraction nozzle 24c, the second flow path 34 has junctions upstream of the return-side pump 40 to merge the flow of liquid wax W that has been drawn back into the coating material transport subsystem via the extraction nozzles 24c.

In the example illustrated in FIG. 3, the first flow path 32 includes solenoid valves 42 at the inlet end of each delivery nozzle 24d-in FIG. 3, only one of the solenoid valves 42 is shown. The solenoid valves 42 are controlled within the application system 10 to close when a predetermined condition associated with filling the cavity 7 is met. The predetermined condition, and related factors are discussed in further detail below.

In this example, the coating material transport subsystem includes a bypass flow path 44 that interconnects the first and second flow paths 32, 34 in a manner that bypasses the nozzles 24. To this end, the bypass flow path 44 has a first end at which branches off the first flow path 32 between the outflow pump 38 and the separation of the first flow path 32 to the delivery nozzles 24d. A second end of the bypass flow path 44 merges with the second flow path 34 between the return-side pump 40 and the tank 12. An overpressure valve 46 is positioned in the bypass flow path 44.

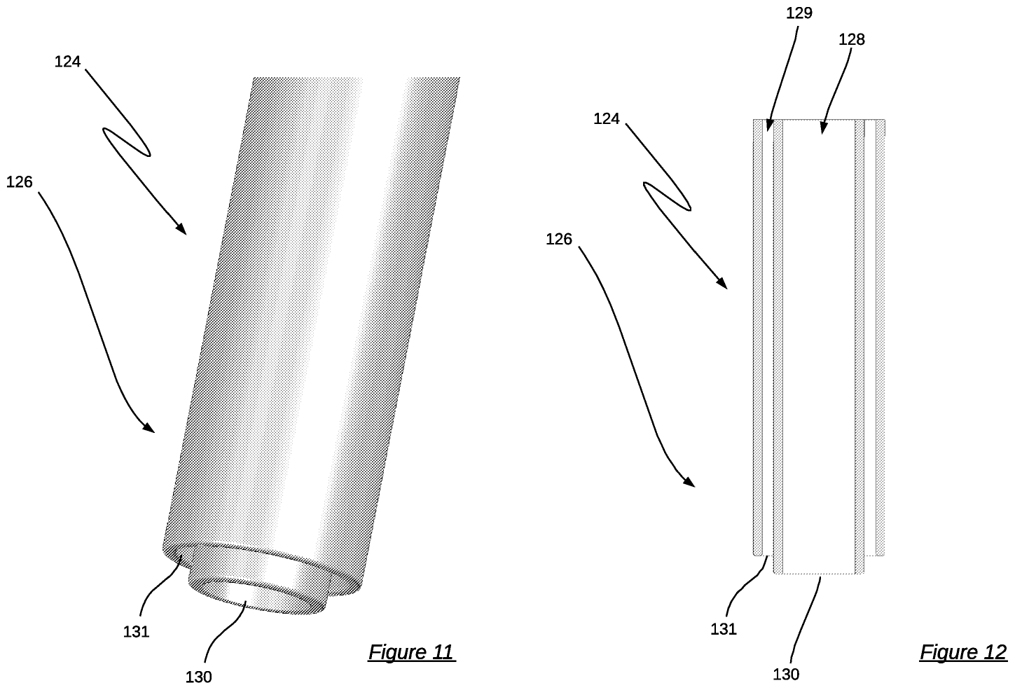

FIGS. 4 to 10 illustrate schematically the application of wax W to the concave surfaces 3 of the blank 1 to thereby form a coating 9 on each concave surface 3. While the method is described in connection with the blank 1, it will be appreciated that the blank 1 is merely a set of twenty conjoined vessels 5. Further, in other examples, the method could be performed on a single article (such as one vessel 5), or simultaneously on any multiple number of articles that may or may not be conjoined.

FIG. 4 illustrates the blank 1 being loaded into the support bed 20, as indicated by block arrow L. The convex surface portions on the underside of the blank 1 locate in the concave nesting formations 22 of the support bed 20. The nesting of the convex surface portions within the concave nesting formations 22 aids in alignment of the blank 1 and support bed 20 laterally with respect to the loading direction (arrow L). As will be appreciated particularly from FIGS. 4 to 7, when the blank 1 is located in its predetermined position on the support bed 20, the concave surfaces 3 are oriented upwardly with respect to the support bed 20.

When the blank 1 is loaded into the support bed 20, the underside of the blank 1 is preferably in direct contact with the upper surface of the support bed 20. This has several benefits in the operation of the application system 10, and in the formation of the coating 9 on the concave surfaces 3, as described in further detail below.

It will be appreciated that in FIG. 4, the support bed 20 can be positioned at the start of the process path P_{F}, and at a location that is laterally spaced from the nozzles 24.

Once the blank 1 is loaded into the support bed 20, the support bed 20 is indexed along the process path P_{F} for application of the coating of wax W.

FIG. 5 illustrates the support bed 20 with concave nesting formations 22 centred with respect to nozzles 24, and thus also the cavities 7 of the blank 1 are centred with respect to the nozzles 24. In FIG. 5, the nozzles 24 are in their elevated positions, with the tip ends 26 above the datum plane P_{D}.

The application system 10 then operates the reciprocation mechanism to move the nozzles 24 into their deployed positions, as shown in FIG. 6. As will be apparent from FIGS. 3, 6, and 7, when the nozzles 24 are in the deployed positions, the tip ends 26 are proximate the concave surfaces 3 of the blank 1. With respect to the delivery nozzles 24d, it is beneficial for the nozzle 24d to occupy volume within the cavity 7, as this minimizes the volume of liquid wax W that needs to discharged to fill the cavity 7 to the rim 6. With respect to the extraction nozzles 24e, it will be appreciated that there is a direct correlation between the spacing of the tip end 26 from the base of the cavity 7 and the thickness of the coating 9 in the base of the cavity 7.

In this particular example, the application system 10 has the set of delivery nozzles 24d that are arranged in a row that extends transversely to the process path P_{F}. In addition, the set of extraction nozzles 24e are also arranged in a row that extends transversely to the process path P_{F}. The rows of delivery and extraction nozzles 24d, 24e are spaced apart in the direction of the process path P_{F} by the separation of adjacent rows of concave nesting formations 22 in the support bed 20, as will be apparent from FIG. 7.

In operation of the application system 10 of this example, once the liquid wax W discharged into fill the cavities 7 in one row of the blank 1 reaches the desired level, the application system 10 then:
ceases the discharge of liquid wax W, by closing solenoid valves 42;
when ready, operates the reciprocation mechanism to move the nozzles 24 and nozzle support chassis 36 to the elevated positions;
operates the support bed translation subsystem to index the support bed 20 forward along the process path P_{F}; and
then operates the reciprocation mechanism to move the nozzles 24 and nozzle support chassis 36 to the deployed positions.

It will be appreciated that in the above phases of operation, the extraction nozzles 24e are being moved into cavities 7 that contain the liquid wax W. In some examples, the return-side pump 40 can be operated to continuously draw fluid (that is, gas, or liquid wax W) into the extraction nozzles 24e and then into the second flow path 34; at least while the extraction nozzles 24e are in positions away from the elevated position. In this way, as soon as the extraction nozzles 24e contact the liquid wax W within the cavities 7 (and prior to the extraction nozzles 24e reaching the deployed positions), the coating material transport subsystem commences extracting the first amount of liquid wax W from the cavities 7.

When the first amount of liquid wax W is extracted from each cavity 7, the residual amount of wax W will remain on the concave surface 3. The residual amount of wax W is then ready to cure, although it will be understood that in practice the curing process of the liquid wax W may have already commenced prior to all of the first amount of liquid wax W being extracted. The application system 10 is then ready to again operate the support bed translation subsystem to index the support bed 20 forward along the process path P_{F}.

In this way, in use of the application system 10, the cavities 7 of the blank 1 are filled with liquid wax W that is discharged from the delivery nozzles 24d, and the first amount of liquid wax W is drawn back from within those cavities 7 via the extraction nozzles 24e for return to the tank 12.

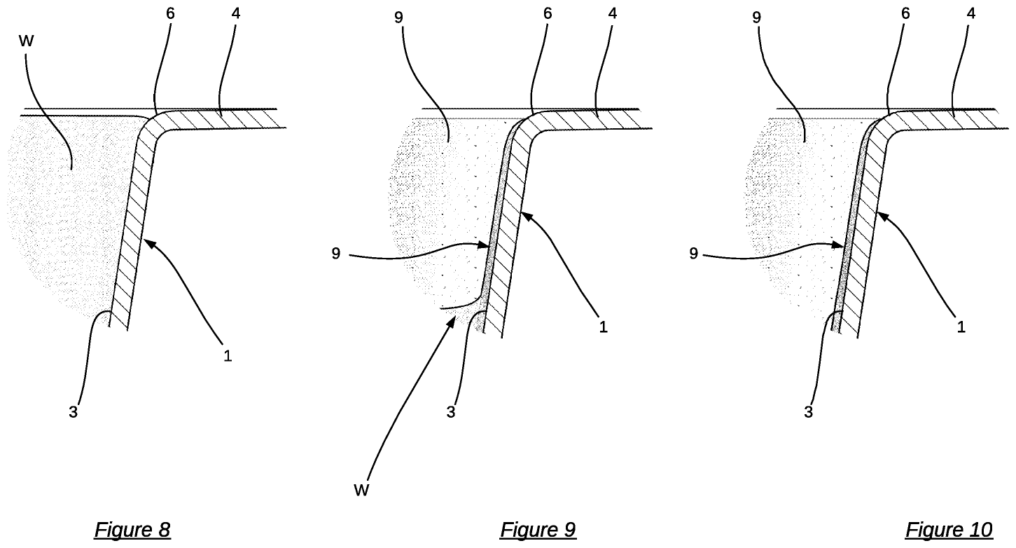

FIGS. 8 to 10 illustrate schematically the sequence of:
a cavity 7 of the blank 1 filled with liquid wax W (FIG. 8);
the extraction of the first amount of liquid wax W, with a thin layer wax partially cured on the concave surface 3; and
the cavity 7 with a cured wax coating 9 of formed as a layer on the concave surface 3.

From FIG. 8, it will be evident that the surface level of the liquid wax W is at, or just below, the level of the rim 6. Further, it will be evident that the cured wax coating 9 is radially inward of the web 4, as previously described in reference to FIG. 2.

The outflow pump 38 can be continuously operated to mitigate the wax W curing within the conduits of the first flow path 32. Accordingly, when the solenoid valves 42 close to halt the discharge of liquid wax W from the delivery nozzles 24d, the fluid pressure in the conduits of the first flow path 32 will rise. The overpressure valve 46 is set to open when the solenoid valves 42 are closed, so as to divert flow of liquid wax W to bypass the delivery nozzles 24d to merge with the second flow path 34, whereupon the wax W will be returned to the tank 12.

As will be appreciated, for application systems that are for use in application of coating materials that are in solid form at atmospheric conditions and in liquid form at elevated temperature, components of the application system will be heated to keep the coating material in liquid form. To this end, in the example of FIG. 3, the nozzles 24, conduit lines of the first, second and bypass flow paths 32, 34, 44, and valves 42, 46 are heated to ensure consistent and reliable operation of the system 10, by maintaining the wax W at a target viscosity during operation.

The application system 10 can include a support bed temperature management subsystem that enables the temperature of the support bed 20 to be maintained at a predetermined temperature. In this example, resistive heating elements 48 are disposed in the support bed 20 to schematically illustrate part of the support bed temperature management subsystem. The heating elements 48 are controlled by the support bed temperature management subsystem to heat the support bed 20. Preferably, the predetermined temperature is to be below the liquid-solid phase transition temperature of the wax W. In this way, the rate of cooling of the wax W in the regions of the cavities 7 that are immediately adjacent the concave surfaces 3 is controllable, and thus the thickness of the coating 9 can be controlled. It will be understood that the components and performance of the support bed temperature management subsystem is dependent on many factors, including the properties (including the temperature) of liquid coating material that is discharged into the cavities 7, the support bed 20, and the environment within which the application system 10 operates. In some application systems, it may desirable or necessary for the support bed temperature management subsystem to alternatively or additionally have cooling circuits to cool the support bed 20.

It will be appreciated that the quantity of liquid wax W within the tank 12 will deplete in use of the application system 10. Accordingly, the quantity of liquid wax W in the tank 12 is replenished via the raw wax feed inlet 14.

The coating material transport subsystem includes flowmeters 52 in the first flow path 32. Each flowmeter 52 is in series with one of the delivery nozzles 24d, and measures the flow rate of wax W that is discharged from the opening of that respective nozzle 24d. More particularly, the flowmeter 54 measures the flow rate of liquid wax W flowing into the delivery nozzle 24d, and from that data the volume of discharged liquid wax W can be inferred.

In this example, the predetermined condition associated with filling the cavity 7 that is used by the application system 10 to close the solenoid valves 42 can be the volume of liquid wax W that is discharged into the respective cavity 7, as determined using data obtained from the flowmeter 52.

The coating material transport subsystem can optionally include flowmeters 54 in the second flow path 34. Each flowmeter 54 is in series with one of the extraction nozzles 24e, and measures the flow rate of wax W that is drawn into the respective extraction nozzle 24e from externally of that nozzle 24c. Data obtained by the flowmeters 54 can be used to assess whether or not the first amount of liquid wax W has been extracted from each cavity 7 via the extraction nozzle 24c.

As indicated above, following application of the coating 9 to the twenty concave surfaces 3 of the blank 1, the blank 1 is cut to form twenty vessels 5, one of which is shown in FIG. 2. For each vessel 5, the wax coating 9 is applied to the concave surface 3, but not to the annular flange 8. The bare material on the upper surface of the annular flange 8 is readily available for further processing steps that involve adhering a separate component (such as a lid) to the vessel 5 radially outwardly of the cavity rim 6.

The above described process to coat the concave surfaces 3 has the benefit that there is no need to mask the web 4 before applying the liquid wax W. Consequently, masking application and removal steps are obviated, with savings in material and processing time. Further, there is minimal waste in needless application of coating material. It will also be recognised that the above described process can minimize the generation of airborne droplets of liquid coating material. Consequently, the process can be used in applying liquid coating materials that are highly volatile, and/or present other dangers when airborne.

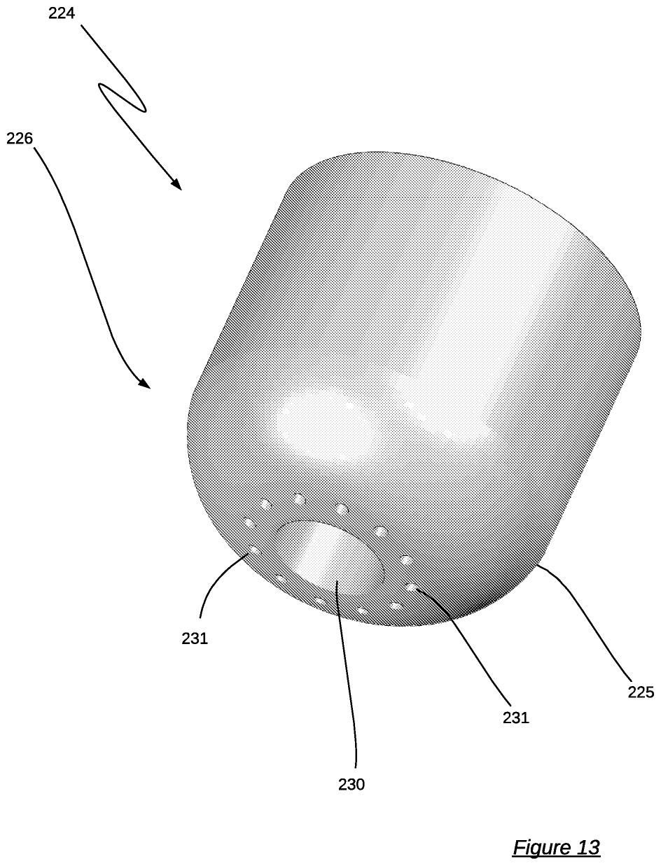

FIGS. 11 and 12 show a tip end of a nozzle 124 of another embodiment. The nozzle 124 has two lumens: a central lumen 128, and an annular lumen 129 that surrounds the central lumen 128. Further, the central lumen 128 opens at the tip end 126 to an inner opening 130, and the annular lumen opens at the tip end 126 to an annular opening 131. As particularly shown in FIG. 12, the annular opening 131 is offset rearwardly from the tip end 126 with respect to the central opening 130.

The nozzle 124 can be connected within an application system such that flow of liquid coating material through the two lumens 128, 129 can be selectively used at different phases of the coating application process. For example, when drawing liquid coating material out of a filled cavity, both lumens 128, 129 can be utilized for an initial period, which provides for high flowrate during the initial extraction. Subsequently, as the liquid coating material level approaches/reaches level of the annular opening 131, the annular lumen 129 can be closed off, thus allowing a slower flowrate that enables more complete extraction of the first amount of liquid coating material in the final extraction.

Alternatively or additionally, liquid coating material can be discharged via the annular lumen 129, and extracted via the central lumen.

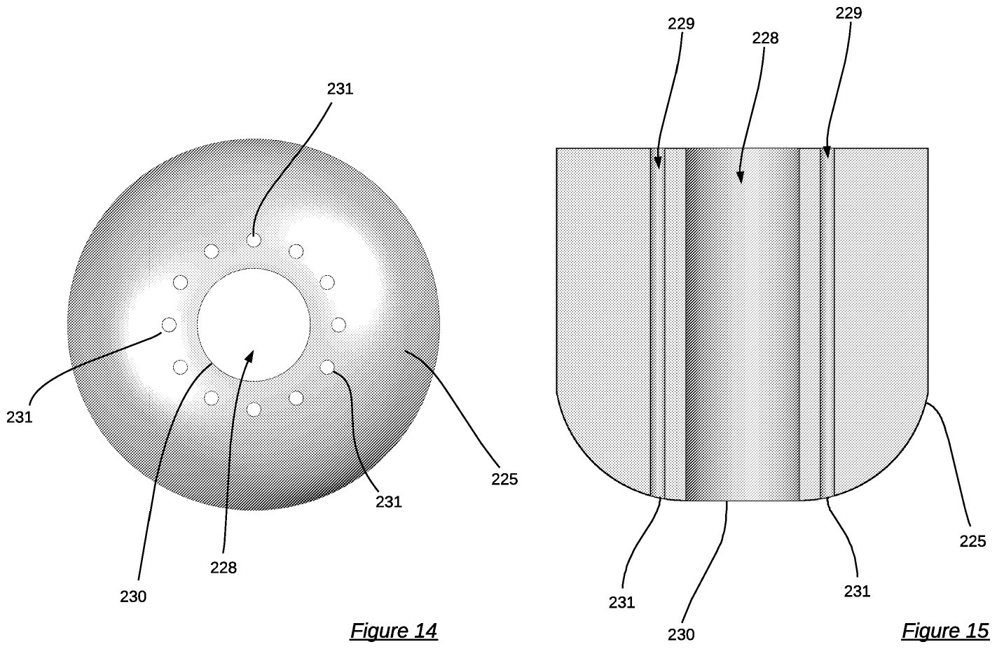

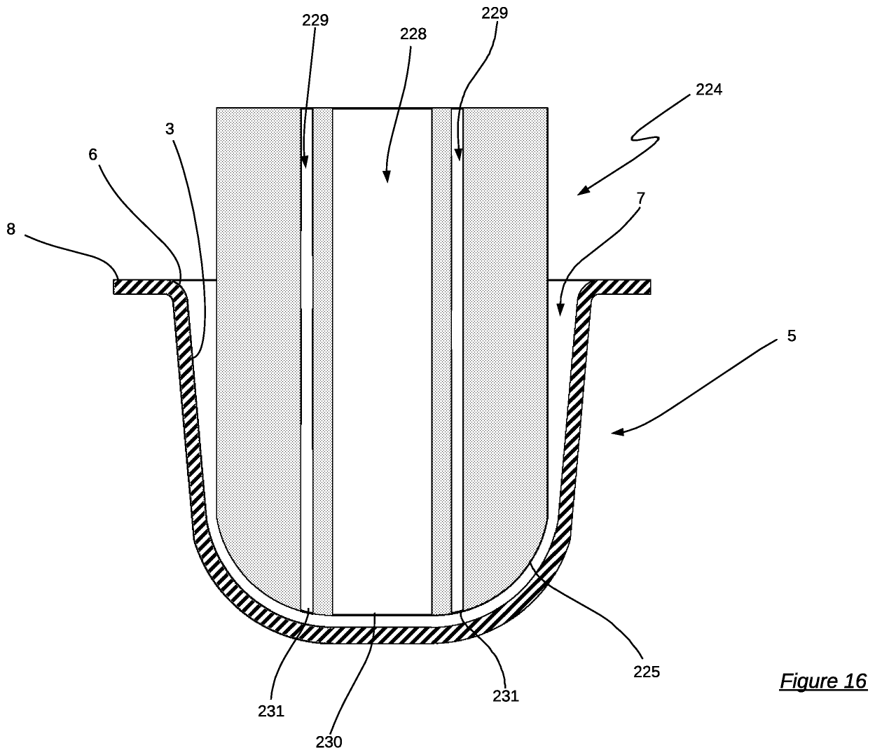

FIGS. 13 to 16 show a tip end of a nozzle 224 according to another embodiment. The nozzle 224 has a central lumen 228 that opens at the tip end 226 to an inner opening 230. The nozzle 224 also has a set of secondary lumens 229 that each open at the tip end 226 to one of a set of outer openings 231. As shown in FIG. 14, the outer openings 231 are arranged about a notional circle that is concentric with the inner opening 230. The central lumen 228, and the set of secondary lumens 229 can be interconnected within an application system in the same manner as the nozzle 124 of FIGS. 11 and 12.

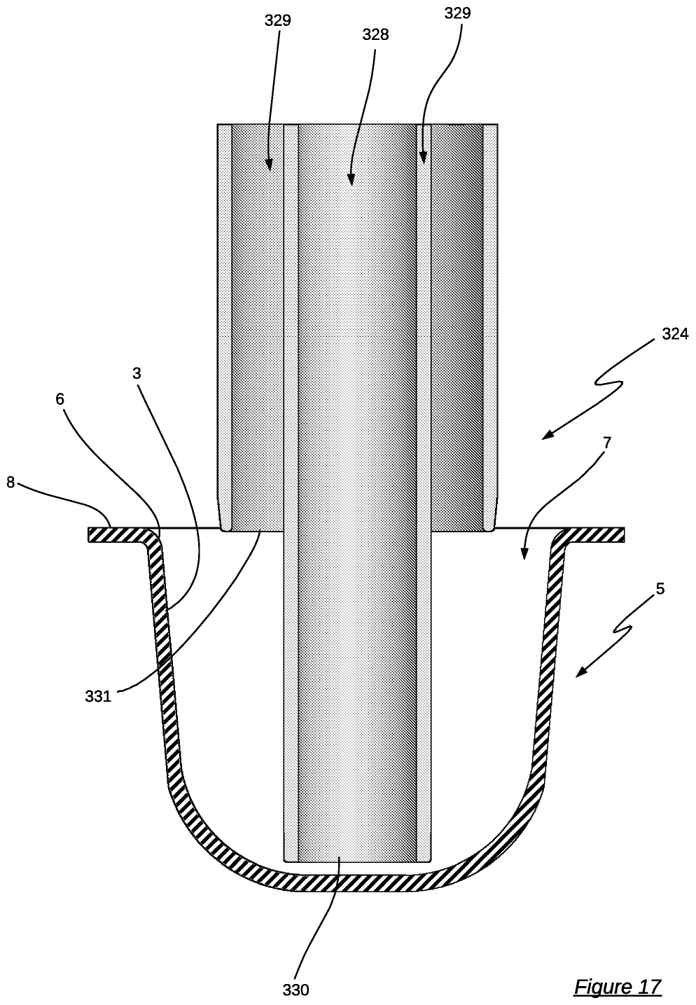

As shown in FIG. 16, the nozzle 224 has a bulbous form, with an outer surface 225 that is proximate the concave surface 3 of the blank 1/vessel 5, when in the deployed position. The nozzle 224 is shaped to occupy a substantial volume of the cavity 7 when in the deployed position. This has the benefit of minimizing the volume of liquid coating material that is to be discharged into the cavity 7 to reach the level of the rim 6.

In addition, by virtue of the increased material volume of the side walls of the nozzle 224, the nozzle 224 can retain heat, which can mitigate liquid coating material curing on the outer surface 225 of the nozzle 224. In some examples, the application system can include heating elements to supply heat to the nozzles 224.

FIG. 17 shows a tip end of a nozzle 324 according to another embodiment. The nozzle 324 is substantially similar in structure to the nozzle 124 of FIG. 11. Parts of the nozzle 324 that are the same or similar to parts of the nozzle 124 have the same reference numbers with the prefix “3” replacing the prefix “1”, and for succinctness will not be described again.

The principal difference between nozzle 324 compared with the nozzle 124 is the larger offset of the annular opening 331 from the central opening 330. When the nozzle 324 is in the deployed position and within the cavity 7 of a vessel 5 (as shown in FIG. 16), the annular opening 331 is in a horizontal plane that is coincident with the maximum fill level of liquid coating material during the filling phase.

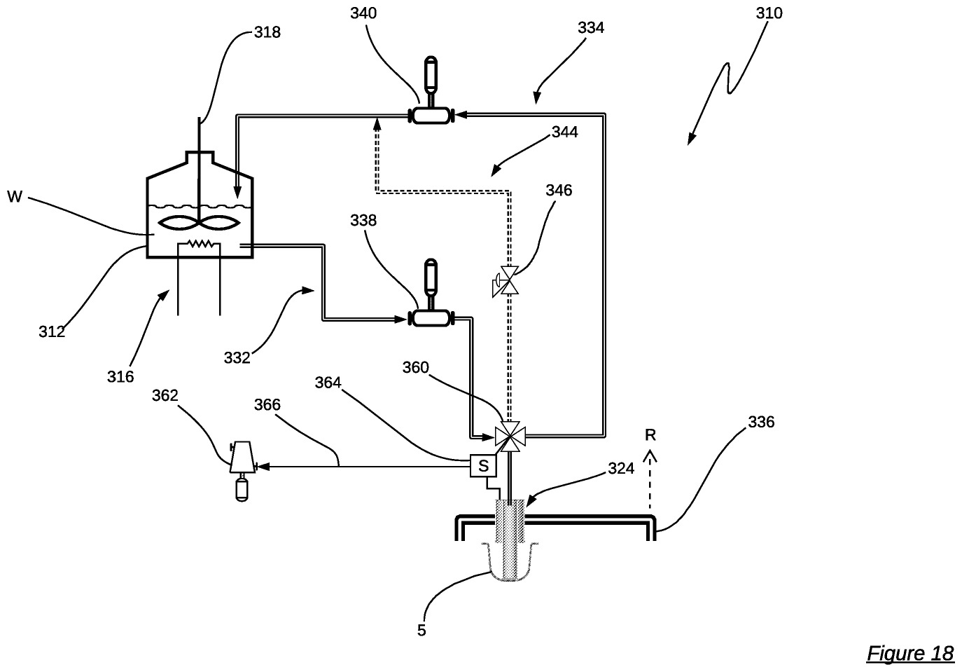

FIG. 18 illustrates an application system 310 that incorporates the nozzle 324. The application system 310 has similar features to the application system 10 of FIG. 3. Parts of the application system 310 that are the same or similar to parts of the nozzle 124 have the same reference numbers with the prefix “3”, and for succinctness will not be described again.

In use of the application system 310 to coat a concave surface of the vessel 5 with a coating material, the nozzle 324 is used both in discharging wax W into the cavity 7, and in extracting the first amount of wax W out from within the cavity 7, thereby leaving the residual amount of wax W coating the concave surface.

The application system 310 includes a valve 360. The first flow path 332 terminates at a first port of the valve 360, and the second flow path 334 starts from a second port of the valve 360. A third port of the valve 360 leads directly to the central lumen 328 of the nozzle 324.

The annular lumen 329 is connected via a vacuum line 366 to a vacuum pump 362. A trigger device, which in this embodiment is in the form of a venturi device 364, is positioned in the vacuum line 366. The venturi device 364 is interconnected with the stem of the valve 360, such that the operating state of the valve 360 is governed by the venturi device 364. Thus, the annular opening 331 is effectively a port to the venturi device 364.

The venturi device 364 has a first state when there is a first gas pressure in the vacuum line 366. This first state corresponds with the annular opening 331 being vented to atmosphere. The valve 360 has a first operating state when the venture device 364 is in its first state. In this first operating state, the valve 360 has the first and third ports open, and the second port is closed. Accordingly, wax W is able to flow from the tank 312 through the central lumen 328 of the nozzle 324 for discharge into the cavity 7.

The venturi device 364 has a second state when there is a second gas pressure in the vacuum line 366 that is lower than the first gas pressure. When the annular opening 331 is obstructed, for example by the annular opening 331 being covered by wax W, the gas pressure within the vacuum line 366 drops below atmosphere, and the venturi device 364 changes to its second state. The valve 360 has a second operating state when the venture device 364 is in its second state. In this second operating state, the valve 360 has the second and third ports open, and the first port is closed. Accordingly, wax W is drawn into the central lumen 328 from externally of the nozzle 324 and returned to the tank 12.

The valve 360 also forms a junction within the coating material transport subsystem. To this end, the valve 360 includes a fourth port that is permanently open to a bypass flow path 344. The bypass flow path 344 merges with the second flow path 334 between the return-side pump 340 and the tank 312. An overpressure valve 346 is positioned in the bypass flow path 344. In the event of an excess pressure within either the first or second flow paths 332, 334, the overpressure valve 346 opens to allow wax W to divert and return to the tank 312.

FIG. 19 is a vertical cross section through a vessel 405 that has a side wall 402a, and a base 402b. The vessel 405 has a generally concave surface 403, a rim 406 at the top of the side wall 402a, and a cavity 407 that is defined between the concave surface 403 and the rim 406. An annular flange 408 extends radially outwardly from the rim 406.

The vessel 405 includes a punt 470 that is positioned within a central portion of the base 402b with respect to the 405. Notwithstanding that the punt 470 creates a convexity with respect to the cavity 407 side of the base 402b, it will be apparent from FIG. 19 that the surface 403 as a whole is generally concave. Further, the punt 470 also creates an annular sump 472 in the concave surface 403.

FIG. 22 shows the vessel 405 with a coating 409 applied to the concave surface 403. The coating 409 is formed from application of a coating material in a liquid form, as described in further detail below, which is then cured. Similarly with the vessel 5 shown in FIG. 2, the coating 409 is not applied to the annular flange 408. Again for simplicity, wax W is used as an illustrative example of the coating material.

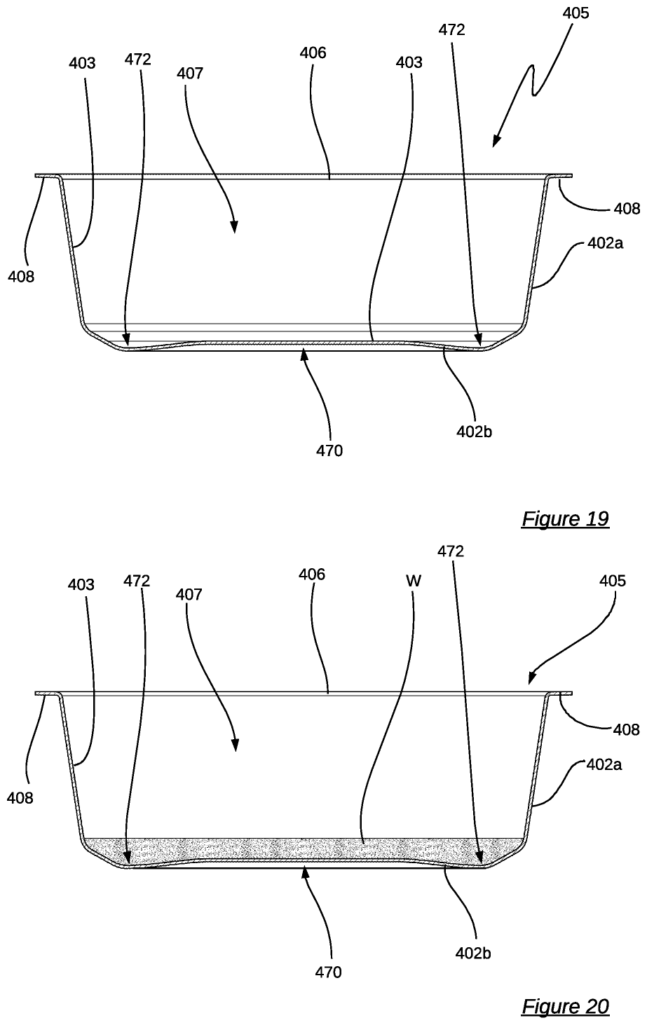

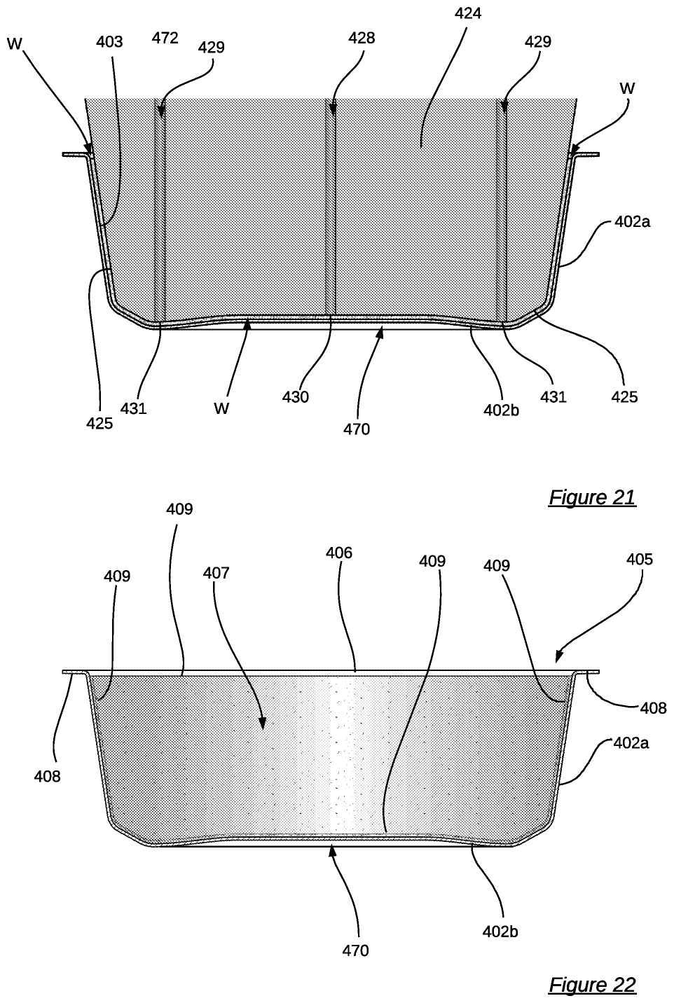

FIGS. 20 and 21 show phases of applying the wax W to the concave surface 403. Liquid wax W is discharged into the cavity 407. In this example, the volume of wax W that is discharged into the cavity 407 is a predetermined volume of wax W. The predetermined volume is less than the volumetric capacity of the cavity 407. FIG. 20 illustrates the vessel 405 after the predetermined volume of wax W is discharged into the cavity 407.

A nozzle 424 of an application system is used in extracting a first amount of the discharged wax W from the cavity 407. FIG. 21 illustrates the nozzle 424 schematically in vertical cross section, with the nozzle 424 located in the deployed position.

The nozzle 424 has a central lumen 428 that opens at a central opening 430, and an annular lumen 429 that opens at an annular opening 431. The outer surface 425 of the nozzle 424 is shaped to substantially complement the shape of the concave surface 403. In this example, the central lumen 428 is positioned within the nozzle 424 such that the central opening 430 aligns with the centre of the punt 470 when the nozzle 424 is in the deployed position. Further, the annular lumen 429 is spaced radially from the central lumen 428 such that the annular opening 431 is aligned with the annular sump 472.

In this particular example, after the predetermined volume of wax W has been discharged into the cavity, the nozzle 424 is inserted into the discharged wax W. This action displaces liquid wax W upwardly within the cavity 407. In other words, liquid wax is displaced towards the rim 406 of the cavity 407, within the space between the side wall 402a and the nozzle 424, thus coating the side wall 402a to the rim 406.

Further, simultaneously with moving the nozzle 424 into the deployed position, liquid wax W is drawn from the cavity 407 through the central and annular lumens 428, 429 and into the second flow path of the coating material transport subsystem. In doing so, the first amount of liquid wax W is extracted from the cavity 407, leaving the residual amount to coat the concave surface 403.

The shape of the outer surface 425 of the nozzle 424 is such that the central opening 430 is rearward of the annular opening 431 with respect to the insertion direction of the nozzle 424. In other words, the portion of the outer surface 425 that is radially inward of the annular opening 431 has a slight concavity. To mitigate the possibility of air being trapped against the portion of the outer surface 425 that is radially inward of the annular opening 431, negative pressure may be applied to the central lumen 428 for a period before negative pressure is applied to the annular lumen 429. In this way, any trapped air can be extracted from the space between the nozzle 424 and the base 402b.

FIG. 22 shows the vessel 405, in schematic vertical cross section, after the nozzle 424 has been removed from the cavity 407, and after the residual amount of wax W has cured to form the coating 409.

It will be appreciated that the exemplary application procedure that is described in connection with FIGS. 19 to 22 has additional benefit in reducing the quantity of liquid coating material that is discharged into the cavity. Particularly as the volumetric capacity of the vessel cavity increases, there is a resulting process efficiency. In addition, the susceptibility for contamination in the extracted liquid coating material may be reduced.

The nozzle 424 itself may be constructed such that the outer surface 425 has a surface energy that is lower than the surface energy of the liquid wax W. This construction mitigates liquid wax W adhering to the outer surface 425 during application of the wax W. In some examples, the nozzle 424 may be formed from a material that has a low surface energy, may have a surface layer of a material that has a low surface energy, and/or the outer surface may be finished to minimize the surface energy.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-37. (canceled)

38. An application system for use in coating a generally concave surface of an article with a coating material, the article further having a rim around the concave surface, and a cavity that is defined between the concave surface and the rim, the application system comprising:
a reservoir within which to contain the coating material in a liquid form,
one or more nozzles that each have a tip end, and at least one lumen that extends through the nozzle to a respective opening at the tip end, and
a coating material transport subsystem that is in communication with the reservoir and the nozzles, the coating material transport subsystem being configured to deliver liquid coating material to at least some of the lumens for discharge via the respective openings, and to draw liquid coating material into at least some of the nozzles from externally of the respective nozzle.

39. The application system of claim 38, wherein the coating material transport subsystem further comprises:
a first flow path through which to transport liquid coating material from the reservoir to a first set of the lumens for discharge via the respective openings, and
a second flow path through which to transport liquid coating material from externally of the respective nozzles, into and through a second set of lumens to the reservoir.

40. The application system of claim 39, further comprising:
at least one support bed with one or more location formations that are each shaped to locate the article to a predetermined position on the support bed with the concave surface oriented upwardly with respect to the support bed,
a nozzle support chassis on which the nozzles are mounted, and
a reciprocation mechanism that is configured to move the nozzle support chassis or the support bed, such that the nozzles are movable relative to the support bed between a deployed position in which, in use of the application system, the tip ends of the nozzles are located within the cavity of the article, and an elevated position in which the tip ends are spaced above the support bed.

41. The application system of claim 40, wherein the location formations include concave nesting formations that complement convex surface portions on an underside of the article,
wherein when the article is supported on the support bed, the convex surface portions on the underside of the article nest within the concave nesting formations.

42. The application system of claim 41, wherein the support bed has a datum plane, and the concave nesting formations are located to a lower side of the datum plane,
wherein:
when the nozzles are in the deployed position, the tip ends are located below the datum plane, and
when the nozzles are in the elevated position, the tip ends are spaced above the datum plane.

43. The application system of claim 42, wherein the application system is configured such that when the nozzles are in the deployed position, the tip ends are disposed at a predetermined insertion depth from the datum plane in a direction that is normal to the datum plane.

44. The application system of claim 40, wherein the nozzle support chassis includes limit stops that at least partially define the deployed position, and that also limit movement of the nozzles in away from the elevated position.

45. The application system of claim 39, wherein each nozzle includes at least one discharge lumen that is interconnected with the first flow path, and at least one extraction lumen that is interconnected with the second flow path.

46. The application system of claim 39, wherein the coating material transport subsystem is configured such that at least some of the lumens of each nozzle are interconnected with both the first and second flow paths,
wherein liquid coating material can be discharged from, and drawn into the respective lumens.

47. The application system of claim 39, wherein the nozzles include:
one or more delivery nozzles that are interconnected with the first flow path, and
one or more extraction nozzles that are interconnected with the second flow path,
wherein, in use of the application system to coat the concave surface of an article, liquid coating material is discharged into the cavity via the delivery nozzles, and liquid coating material is drawn from the cavity into the second flow path via the extraction nozzles.

48. The application system of claim 42, wherein the nozzles include:
one or more delivery nozzles that are interconnected with the first flow path, and
one or more extraction nozzles that are interconnected with the second flow path,
wherein, in use of the application system to coat the concave surface of an article, liquid coating material is discharged into the cavity via the delivery nozzles, and liquid coating material is drawn from the cavity into the second flow path via the extraction nozzles, and
wherein the delivery and extraction nozzles are mounted on the nozzle support chassis, and arranged such that:
the delivery nozzles are mounted in a delivery nozzle array,
the extraction nozzles are mounted in an extraction nozzle array, and
the tip ends of the delivery and extraction nozzles are in fixed positions relative to the nozzle support chassis.

49. The application system of claim 48, further comprising a support bed translation mechanism that is configured to move the support bed along a process path,
wherein, in at least one direction of movement of the support bed along the process path, the support bed halts to allow the delivery nozzles to reciprocate from the elevated position to the deployed position in the concave nesting formations and subsequently to allow the extraction nozzles to reciprocate from the elevated position to the deployed position in the respective concave nesting formations.

50. The application system of claim 49, wherein the support bed translation mechanism is configured to index the support bed along the process path in at least one direction through a set of two or more predetermined positions,
wherein each predetermined position corresponds with concave nesting formations being located such that at least one of the nozzles is locatable in its deployed position within cavity of the respective concave nesting formations.

51. The application system of claim 48, wherein the arrays of delivery nozzles and extraction nozzles are arranged so that, in use the of the application system and when the support bed is located at each of the predetermined positions, delivery nozzles are to discharge liquid coating material into the cavities of a group of articles and the extraction nozzles are to draw liquid coating material from the cavities of that same group of articles.

52. The application system of claim 42, wherein the support bed has an array of concave nesting formations that are arranged in the datum plane into linear rows and columns.

53. The application system of claim 38, wherein at least some of the nozzles are to be inserted into the discharged liquid coating material while drawing liquid coating material into at least some of the nozzles from externally of the respective nozzle, and those nozzles are constructed with outer surfaces that have a surface energy that is lower than that of the liquid coating material.

54. The application system of claim 40, further comprising a support bed temperature management subsystem that enables the temperature of the support bed to be maintained at a predetermined temperature,
wherein the predetermined temperature is to be below the liquid-solid phase transition temperature of the coating material, and
the predetermined temperature is adjustable.

55. The application system according to claim 41, further comprising a locating subsystem to facilitate supporting the article against the concave nesting formations, the locating subsystem being arranged to apply a force against the article when loaded onto the support bed to urge the article into contact with the concave nesting formations.

56. The application system of claim 38, wherein the coating material transport subsystem includes one or more flowmeters that are configured to measure the flow rate of liquid coating material that is discharged from the respective openings of the nozzles.

57. The application system of claim 56, wherein the coating material transport subsystem is arranged with one of the flowmeters associated with a respective one of the nozzles to measure the flow rate that is discharged from the opening of that respective nozzle.
